(19) United States
(12) Patent Application Publication
(10) Pub. No.: US 2014/0379462 A1
(43) Pub. Date: Dec. 25, 2014

(54) REAL-TIME PREDICTION MARKET

(71) Applicant: Microsoft Corporation, Redmond, WA (US)

(72) Inventors: Nikhil Devanur Rangarajan, Seattle, WA (US); David Pennock, Princeton, NJ (US); Miroslav Dudik, Brooklyn, NY (US); Zhiyi Huang, Philadelphia, PA (US)

(73) Assignee: Microsoft Corporation, Redmond, WA (US)

(21) Appl. No.: 13/923,388

(22) Filed: Jun. 21, 2013

(51) Int. Cl. G06Q 30/02

(52) U.S. Cl. CPC G06Q 30/0247
USPC 705/14.46

(57) ABSTRACT

A real-time prediction market is described. A plurality of predictor agents set forth respective predictions as to a likelihood that an advertisement will be selected when displayed together with certain publisher content. The advertisement is selected from amongst a plurality of advertisements based upon the plurality of predictions set forth by the plurality of predictor agents. Third parties corresponding to the predictor agents are compensated or penalized as a function of predictive accuracy of the predictor agents.

### BACKGROUND

Advertising is a source of revenue for many Internet-based services. For example, many websites and computer-executable applications are ad-supported, wherein respective publishers receive compensation when end-users perform a predefined action with respect to advertisements that are displayed in connection with a web page or application. Typically, a publisher receives monetary compensation when a user clicks on an advertisement shown on a webpage or application.

With respect to a particular end user, it can therefore be ascertained that it is desirable for the publisher to present an advertisement to the end user that has a relatively high probability of being selected by the end user. In many cases, the publisher is tasked with estimating selection probabilities for advertisements or paying an advertisement server to estimate such selection probabilities. For instance, the publisher can enter into a contract with the advertisement server, wherein the advertisement server selects advertisements for display to end users when such end users view content published by the publisher. In an example, an end user can cause a browser to load a web page of a publisher, and the advertisement server can be notified of such action. The advertisement server then conducts an auction, receiving bids from advertisers with respect to advertisements that are desirably displayed on the web page. The advertisement server computes a selection probability (referred to as click probability or pclick) for each advertisement, and selects one or more advertisements for display on the web page based upon a bid amount and selection probability corresponding to the at least one advertisement (e.g., to maximize revenue for the publisher). When an end user selects the at least one advertisement, the advertisement server charges a corresponding advertiser a fee, and the fee is in some way split between the publisher and the advertisement server.

It can thus be ascertained that computing selection probabilities for advertisements that may be presented together with content published by the publisher is of utmost importance with respect to revenue generation for the publisher. Conventional approaches for computing selection probabilities, either by the publisher directly or by the advertisement server, are based upon data collected by the publisher or the advertisement server in conjunction with data provided by third party data providers who specialize in collecting data about users that can be used to predict interests of such users. With more particularity, generally, the publisher or the advertisement server enter into a long-term contract with the third party data provider who provides user data to the publisher and/or advertisement server. Subsequently, the publisher and/or advertisement server are tasked with properly using the data to predict selection probabilities for advertisements. There are several issues with this conventional approach. First, users may have privacy concerns, in that data that third party data providers collect data about such users, and thereafter sells this data to another entity without knowledge of the users. Additionally, it can be difficult for the publisher and/or advertisement server to ascertain an appropriate value of data provided by the third party data provider, as both parties to the long-term contract risk overvaluing or undervaluing the data. Still further, the data provider may not wish to expose all of its data to a purchaser, and the purchaser may have difficulty ascertaining which data is relevant for the purposes of predicting whether users will interact with advertisements—accordingly, the purchaser (publisher or advertisement server) may purchase data that is not needed.

### SUMMARY

The following is a brief summary of subject matter that is described in greater detail herein. This summary is not intended to be limiting as to the scope of the claims.

Described herein are various technologies pertaining to a real-time prediction market, where computer-executable predictor agents generate predictions as to whether users will select certain respective advertisements, and further wherein third parties associated with such computer-executable predictor agents are compensated based upon prediction accuracy of their respective predictor agents. Advertisements can be selected for presentment to users based at least in part upon predictions generated by the predictor agents. Over time, predictor agents found to have relatively high accuracy with respect to predicting which advertisements will be selected by respective users can be assigned weights such that their predictions are weighted more heavily when determining which advertisements to set forth to end users.

In an exemplary embodiment, the real-time prediction market can receive an indication that content of a publisher is to be displayed on a display screen of a computing device of an end user, wherein such content may be a web page, an application being executed by the end user, a search results page, etc. A plurality of predictor agents can receive a plurality of advertisements that are potentially displayed on the computing device of the user together with the content of the publisher. Each predictor agent can have access to its own private data (which may optionally include cookies retained on the computing device of the end user if authorized by the end user). Using its own respective data, a respective predictor agent can generate predictions (selection probabilities) for a subset of advertisements in the plurality of advertisements that are potentially displayed with the content, wherein the predictions are indicative of likelihoods that the end user will select respective advertisements in the subset of advertisements. Advertisements in the plurality of advertisements potentially displayed with the content can then be ranked based at least in part upon predictions generated by the predictor agents, and an advertisement can be selected for display (with the content) based upon the ranking of the advertisements.

Actions of the user with respect to the displayed advertisement may then be monitored. For example, it can be detected that the user has selected the advertisement displayed together with the content. Third parties corresponding to the respective predictor agents may then be compensated (or optionally penalized) based upon the selection of the advertisement by the user. For example, if a first predictor agent predicted a high probability of the advertisement being selected and the advertisement was subsequently selected by the user, than a third party corresponding to the first predictor agent can receive relatively high compensation due to the relatively high accuracy of the prediction. Alternatively, if the first predictor agent predicted a high probability of the user selecting the advertisement and the user subsequently failed to select the advertisement, the third party corresponding to the first predictor agent may not be compensated (and optionally may be penalized) due to the relatively low accuracy of the prediction. It can therefore be ascertained that a compensation scheme for the real-time prediction market can be designed such that third parties earn higher compensation for more accurate prediction agents.

The exemplary approach described herein alleviates many concerns associated with conventional approaches. For example, privacy of users is better preserved, since data is not exchanged between third parties and publishers (or advertisement servers) unbeknownst to end users. Additionally, the publisher and/or advertisement server is more certain of obtaining value, as compensation paid by the publisher and/or advertisement server to third parties is a function of accuracy of predictions generated by predictor agents of such third parties.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an exemplary system that facilitates executing a real-time prediction market system for utilization in connection with selecting an advertisement for display to an end user.

FIG. 2 is a functional block diagram of an exemplary prediction market component that facilitates selecting an advertisement for display to an end user based upon a plurality of predictions generated by a respective plurality of computer-executable prediction agents as to whether the end user will select such advertisement.

FIG. 3 is a functional block diagram of an exemplary system that facilitates providing a recommendation to an end user based upon a plurality of predictions generated by a respective plurality of prediction agents as to whether the end user will perform a predefined act with respect to the recommendation.

FIG. 4 is a functional block diagram of an exemplary system that facilitates ranking a search result in an ordered list of search results based upon a plurality of predictions output by a respective plurality of prediction agents as to whether a user will select such search result.

FIG. 5 is a flow diagram illustrating an exemplary methodology for selecting an advertisement for display on a computing device of an end user based upon a plurality of predictions from third party predictor agents as to whether the end user will select such advertisement.

FIG. 6 is a flow diagram that illustrates an exemplary methodology for compensating third parties based upon accuracies of respective predictions of computer-executable predictor agents corresponding to such third parties.

FIG. 7 is an exemplary computing system.

### DETAILED DESCRIPTION

Various technologies pertaining to a real-time prediction market are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something, and is not intended to indicate a preference.

Described herein are various technologies pertaining to a real-time prediction market, where data is presented to a user as a function of a plurality of predictions set forth by computer-executable predictor agents as to whether the user will, in a predefined manner, perform an action with respect to such data. In an exemplary embodiment, the real-time prediction market can be used in connection with selecting an advertisement or advertisements for presentment to an end user based upon a plurality of predictions set forth by computer-executable predictor agents as to respective likelihoods of the end user selection the advertisement or advertisements. Third parties corresponding to the predictor agents are compensated as a function of accuracy of predictions of their respective predictor agents. Thus, utilizing the prediction market approach described herein, third parties having computer-executable predictor agents that accurately predict user action with respect to data are provided with higher compensation when compared to third parties having predictor agents with lower accuracy when predicting user action with respect to data.

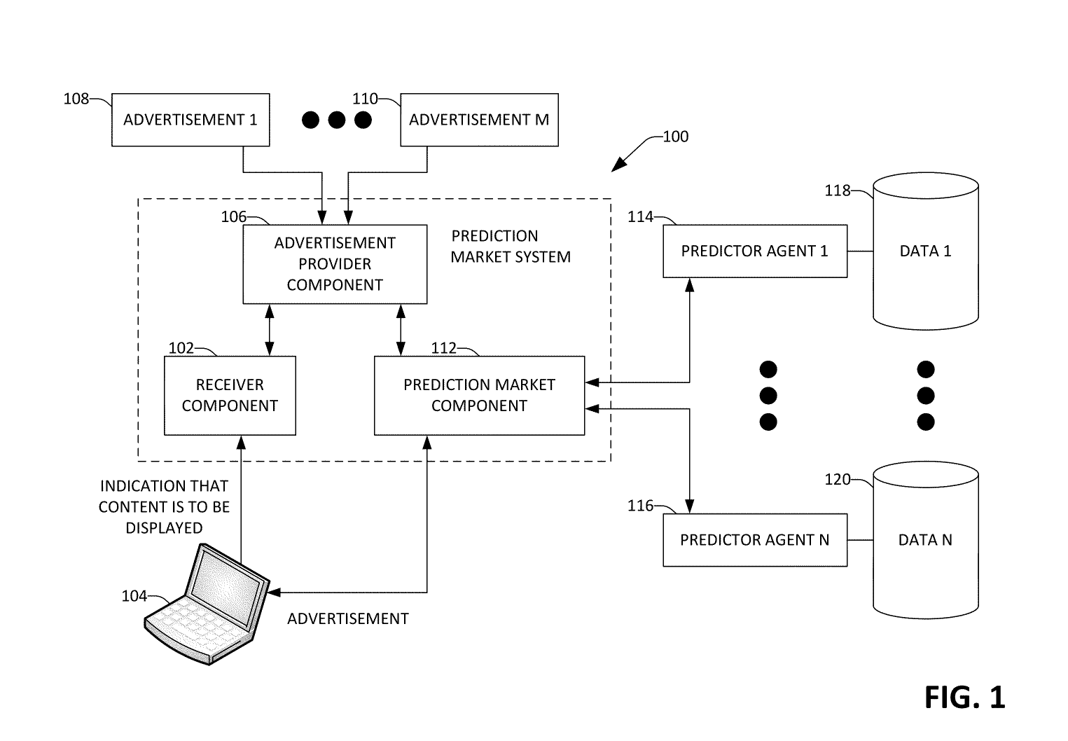

With reference now to FIG. 1, an exemplary prediction market system 100 that facilitates display of an advertisement to an end user based upon a plurality of predictions from a respective plurality of predictor agents as to the likelihood of the end user selecting the advertisement is illustrated. The prediction market system 100 includes a receiver component 102 that receives an indication that content of a publisher is to be displayed on a display screen of a computing device 104. Additionally, the receiver component 102 can optionally receive information that is indicative of an identity of a user that is to view the content on the display screen of the computing device 104. For instance, if authorized by the user of the computing device 104, cookies can retain information that is indicative of the identity of the user and/or indicative of actions previously undertaken on the computing device by the user. In an exemplary embodiment, the content that is to be displayed on the display screen of the computing device 104 may be a web page, and the indication received by the receiver component 102 can be that a web browser executing on the computing device 104 has requested the web page. In another example, the computing device 104 can be executing a computer-executable application of the publisher, and the indication that content is to be displayed on the display screen of the computing device 104 received by the receiver component 102 can be an indication that the application is at a particular state, that the user of the computing device 104 has performed a particular action with respect to the application, that the application is to display certain content, etc. In still yet another example, the indication that content is to be displayed on the display screen of the computing device 104 received by the receiver component 102 can comprise a query that is provided to a search engine, wherein the content to be displayed is search results that are based upon such query.

The computing device 104, while shown as a laptop computing device, may be any suitable computing device. For instance, the computing device 104 may be a desktop computing device, a laptop computing device, a tablet (slate) computing device, a mobile telephone, a wearable, a phablet (e.g., a combination phone/tablet), etc.

The prediction market system 100 may further optionally comprise an advertisement provider component 106 that receives a plurality of advertisements 108-110 that are potentially displayed on the display screen of the computing device 104 together with the content of the publisher. While the advertisement provider component 106 is shown as being included in the prediction market system 100, it is to be understood that the advertisement provider component 106 may execute separately from the prediction market system 100. For example, the advertisement provider component 106 may be included in an advertisement server that executes separately from the prediction market system 100. The advertisement provider component 106 may use any suitable techniques to receive/retrieve the plurality of advertisements 108-110. For example, the advertisement provider component 106 can execute an auction, and the plurality of advertisements 108-110 may have respective bids corresponding thereto submitted to the advertisement provider component 106.

The prediction market system 100 additionally comprises a prediction market component 112 that receives the plurality of advertisements 108-110 and provides the plurality of advertisements 108-110 (or features corresponding to the advertisements 108-110) to a plurality of predictor agents 114-116. The prediction market component 112 may also optionally provide the plurality of predictor agents 114-116 with contextual information pertaining to the advertisement opportunity, such as type of the computing device 104, geographic location of the computing device 104, and other contextual data that may be relevant to the selection of at least one advertisement from the advertisements 108-110 for display on the display screen of the computing device 104 together with the publisher content requested by the computing device 104. Further, one or more of the prediction agents 114-116 and/or the prediction market component 112 can receive data that is indicative of an identity of the user of the computing device 104 (if authorized by the user). In an exemplary embodiment, the prediction market component 112 can select the plurality of predictor agents 114-116 from a pool of predictor agents based upon a set of predefined criteria. Such predefined criteria can include, but is not limited to, keywords in the publisher content that is to be displayed on the display screen of the computing device 104, keywords in a query submitted by way of the computing device 104, demographic information about the end user of the computing device 104 (e.g. age, gender, geographic location, . . . ), etc. For example, predictor agents in the pool of predictor agents can submit criteria that indicates when the predictor agents would like to be notified about an advertisement opportunity, and the prediction market component 112 can trigger the plurality of predictor agents 114-116 based upon such criteria.

The plurality of predictor agents 114-116 have access to their own respective private data 118-120, wherein the predictor agents 114-116 can respectively use the data 118-120 to generate predictions as to respective likelihoods of the end user selecting the plurality of advertisements 108-110 when displayed together with the publisher content. Thus, for instance, the first predictor agent 114 has access to the first private 118, while the Nth predictor agent 116 has access to Nth private data 120. The private data 118-120 can optionally include data from the computing device (such as cookies) if authorized by the end user. Moreover, each predictor agent in the plurality of predictor agents 114-116 can retain state information as to its respective prediction performance over time.

As noted above, the predictor agents 114-116 can use their respective private data 118-120 to generate predictions for respective advertisements in the plurality of advertisements 108-110 as to the likelihood of the end user selecting such advertisements if displayed on the display screen of the computing device 104 together with the publisher content requested by the computing device 104. In an exemplary embodiment, a prediction set forth by a predictor agent may be in the form of a selection probability (click probability). Thus, for instance, the first predictor agent 114 can output a prediction for the first advertisement 108 that indicates that there is a 10% probability that the user of the computing device 104 will select the first advertisement 108 if the first advertisement 108 is displayed together with the publisher content. In another example, a prediction generated by a predictor agent can be binary in nature (e.g., yes or no), and have a confidence score assigned to such binary value.

Further, a predictor agent can be configured to output multiple predictions with respect to an advertisement. For example, the publisher content may include several regions where advertisements can respective be displayed, and the predictor agent can generate predictions as to respective likelihoods of an advertisement being selected by the end user for each of such locations. Still further, a predictor agent in the predictor agents 114-116 can generate conditional predictions when multiple advertisements are to be displayed with the publisher content. For instance, the first predictor agent 114 can indicate that the first advertisement 108 has a first probability of being selected by the end user if displayed concurrently with a second advertisement, but has a second probability of being selected by the end user if displayed concurrently with a third advertisement. Still further, a predictor agent in the plurality of predictor agents 114-116 can be configured to submit a confidence score/wager together with a prediction, which can be used in connection with compensating or penalizing the predictor agent.

It is to be understood that a predictor agent need not generate predictions for each advertisement in the plurality of advertisements 108-110. For example, the first predictor agent 114 can generate a prediction as to the likelihood of the first advertisement 108 being selected by the end user if displayed together with the publisher content while failing to set forth a prediction for the Mth advertisement 110. Thus, predictor agents in the plurality of predictor agents 114-116 are free to abstain from generating predictions as the likelihood of end user selection of one or more advertisements in the advertisements 108-110.

The prediction market component 112 can receive the predictions output by the plurality of predictor agents 114-116 with regard to the plurality of advertisements 108-110, and can rank advertisements in the plurality of advertisements 108-110 based upon the predictions received from the plurality of predictor agents 114-116. The prediction market component 112 can additionally rank advertisements in the plurality of advertisements 108-110 based upon bid amounts corresponding to such advertisements 108-110. Thus, in an exemplary embodiment, the prediction market component 112 can select an advertisement for display on the computing device 104 together with the publisher content to maximize revenue for the publisher. The prediction market component 112 can select at least one advertisement from the plurality of advertisements 108-110 based upon the ranking of advertisements in the plurality of advertisements 108-110, and therefore based upon the predictions generated by the predictor agents 114-116. Additionally, the prediction market component 112 can optionally generate predictions for advertisements in the plurality of advertisements 108-110 as to the respective likelihoods of such advertisements being selected by the end user when displayed with the requested publisher content. The prediction market component 112 may, thus, use its own predictions together with predictions generated by the predictor agents 114-116 to rank advertisements in the plurality of advertisements 108-110, and can select at least one advertisement for display with the publisher content. In another exemplary embodiment, the prediction market component 112 can choose to refrain from selecting and displaying an advertisement on the display screen of the computing device 104.

The prediction market component 112 can also be configured to receive an indication as to whether the end user of the computing device 104 has selected the at least one advertisement when the advertisement is displayed with the publisher content. Selection of the advertisement may be a click of the advertisement, depression of a touch-sensitive screen on the advertisement, a voice selection of the advertisement, etc. In other exemplary embodiments, selection of the advertisement may require navigating to a particular web page, purchasing an item, or performing some other predefined event.

Responsive to receiving the indication as to whether or not the user has selected the advertisement, the prediction market component 112 can compensate (or optionally penalize) third parties corresponding to the predictor agents 114-116 based upon accuracies of their respective predictions. Thus, in an example, if the first predictor agent 114 generated a first prediction that the first advertisement 108 was highly likely to be selected by the end user when displayed with the publisher content and the end user, in fact, selected the first advertisement 108, the prediction market component 112 can compensate a first third party corresponding to the first predictor agent 114 for the relatively highly accurate prediction. Conversely, if the Nth predictor agent 116 indicated a very low likelihood that the first advertisement 108 would be selected by the end user when displayed with the publisher content, and the first advertisement 108 was, in fact, selected by the end user, then the prediction market component 112 can optionally penalize an Nth third party corresponding to the Nth predictor agent 116 for the relatively poor prediction. Over time, then, the prediction market component 112 can compensate (or optionally penalize) third parties for respective predictor agents as a function of the accuracy of predictions generated by the predictor agents, such that the first third party corresponding to the first predictor agent 114 may be compensated more or less than the Nth third party corresponding to the Nth predictor agent, depending upon relative accuracy of predictions of the first predictor agent 114 and the Nth predictor agent 116. Further, the prediction market component 112 can compensate third parties corresponding to predictor agents as a function of wager or confidence levels assigned to predictions by predictor agents. In cases where the prediction market component 112 does not select an advertisement for display on the computing device 104, the predictor agents 114-116 are neither compensated nor penalized.

In an exemplary embodiment, the prediction market system 100 can be executed as a zero sum game amongst the pool of predictor agents, such that third parties having predictor agents that output relatively high accuracy predictions are compensated at the expense of third parties having predictor agents that output relatively low accuracy predictions. In another exemplary embodiment, the prediction market system 100 may be a subsidized system, in that the publisher or advertisement server subsidizes the prediction market system 100 such that penalties assessable to third parties are limited. For instance, the prediction market component 112 can be configured to only compensate and not penalize, wherein the publisher or advertiser server subsidizes compensation to third parties having accurate prediction agents.

Further, as the prediction market system 100 is able to ascertain relative accuracies of predictor agents, predictions output by predictor agents can be weighted as a function of historic accuracies of such predictor agents. Therefore, the prediction market component 112 can weight predictions generated by more accurate predictor agents more highly when compared to predictions generated by historically less accurate predictor agents. As accuracies of predictor agents change over time, weights assigned to predictions output by such predictor agents by the prediction market component 112 can likewise change.

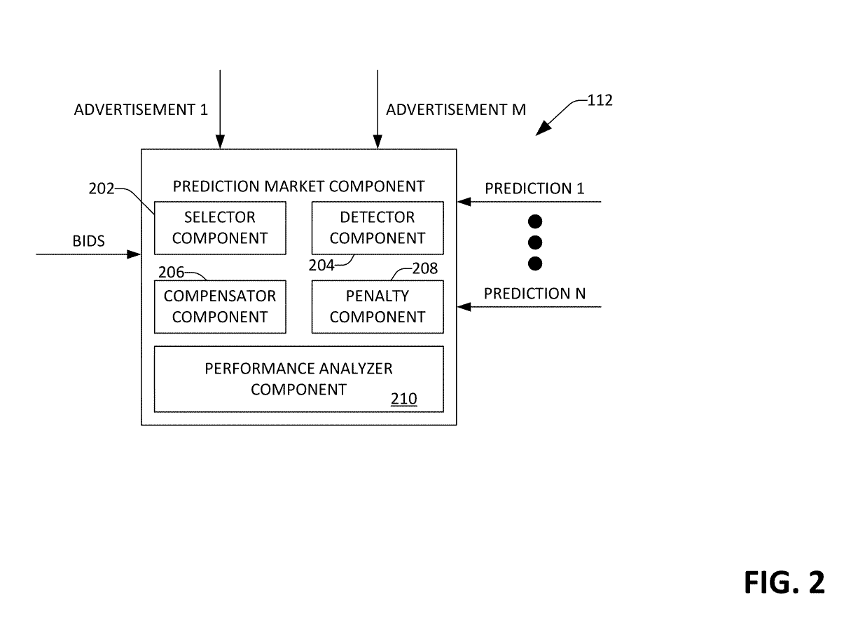

With reference now to FIG. 2, an exemplary depiction of the prediction market component 112 is illustrated. As indicated above, the prediction market component 112 receives a plurality of advertisements that are potentially displayed on the display screen of the computing device 104 to the end user together with publisher content requested by the computing device 104. The prediction market component 112 receives a plurality of predictions from a plurality of computer-executable predictor agents as to respective likelihoods of advertisements in the plurality of advertisements being selected by the end user when such advertisements are displayed to the end user together with the publisher content. The prediction market component 112 can also optionally receive respective bids corresponding to the plurality of advertisements.

The prediction market component 112 includes a selector component 202 that selects at least one advertisement from the plurality of advertisements for display on the display screen of the computing device 104 based upon predictions pertaining to the at least one advertisement from the plurality of predictor agents. Additionally, the selector component 202 can take into consideration the bids corresponding to the plurality of advertisements, and optionally a prediction generated by the prediction market component 112 itself when selecting the at least one advertisement for presentment to end user with the publisher content.

The prediction market component 112 also includes a detector component 204 that receives an indication of user interaction with the at least one advertisement selected by the selector component 202. Thus, the detector component 204 can detect whether or not the user clicked on the at least one advertisement or performed some other predefined action with respect to the at least one advertisement. A compensator component 206 can then provide compensation to one or more of the predictor agents based upon the action detected by the detector component 204. Thus, a first third party can have a first predictor agent that generated a more accurate prediction when compared to a prediction generated by a second predictor agent of a second third party. In such situation, the compensator component 206 provide more compensation to the first third party when compared to the second third party.

The prediction market component 112 may also include a penalty component 208 that can penalize third parties corresponding to predictor agents for relatively inaccurate predictions. Thus, if the first predictor agent generates a prediction indicating a high likelihood of selection of the at least one advertisement by the end user, and the detector component 204 detects that the user fails to select the at least one advertisement, the penalty component 208 can penalize the first third party corresponding to the first predictor agent. As noted above, the compensator component 206 and/or the penalty component 208 can also take into consideration confidence levels and/or wagers corresponding to predictions set forth by predictor agents when ascertaining an amount of compensation or penalty for third parties corresponding to such predictor agents.

The prediction market component 112 may further include a performance analyzer component 210 that analyzes historic prediction accuracies of predictor agents and assigns weights to predictor agents and/or predictions as a function of the historic prediction accuracies. For instance, if a first predictor agent is found to be relatively highly accurate over time compared to a second predictor agent, then predictions output by the first predictor agent can be weighted more highly than predictions output by the second predictor agent. The selector component 202 can, thus, select that at least one advertisement for display on the display screen of the computing device 104 with the publisher content as a function of historic performance of predictor agents as monitored by the performance analyzer component 210.

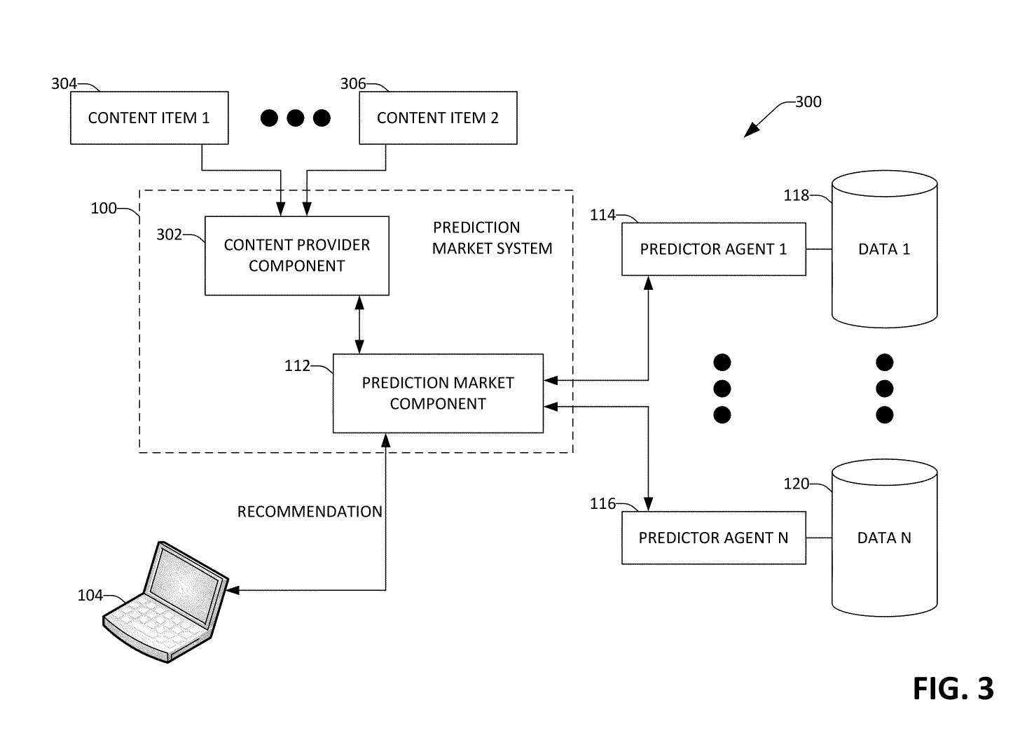

With reference now to FIG. 3, an exemplary system 300 that facilitates provision of content to the end user as a function of predictions as to relevancy of such content to the end user is illustrated, wherein the predictions are generated by the plurality of predictor agents 114-116. In an exemplary embodiment, the system 300 may be used as a portion of a recommendation system, where the prediction market system 100 is configured to output predictions to the end user as to a product, service, etc. Such product may be a product purchasable by way of an online retail website, a video, a song, a restaurant, etc.

In the exemplary system 300, the prediction market system 100 includes a content provider component 302 that receives a plurality of content items 304-306 that may optionally be presented to the user of the computing device 104. As indicated above, the content items 304-306 may represent items that are purchasable by the end user by way of the computing device 104. In another example, the content items 304-306 may represent videos that can be watched by the user of the computing device 104 by way of a computer-executable application. In still yet another example, the content items 304-306 can represent songs that may be listened to by the user by way of the computing device 104. In an exemplary embodiment, the content provider component 302 can identify the content items 304-306 based upon historic actions of the end user of the computing device 104, contextual information, historic actions of other users, etc.

The prediction market component 112 receives the plurality of content items 304-306 that are potentially presented to the user by way of the computing device 104, and selects the plurality of predictor agents 114-116 from the pool of predictor agents based upon predefined criteria. The predictor agents 114-116 are configured to use their respective privately held data 118-120 to predict whether the user of the computing device 104 will perform some predefined action (within a threshold amount of time) with respect to content items in the plurality of content items 304-306 if presented to the user on the display screen of the computing device 104. In an exemplary embodiment, the content items 304-306 can represent movies, and the predictor agents 114-116 can be configured to output predictions as to whether the end user of will enjoy such movies if the user watches the movies (and therefore provides a high ranking to the movies). In another embodiment, the content items 304-306 can represent items that are purchasable by way of the computing device 104, and the predictor agents 114-118 can predict a likelihood that the user of the computing device 104 will purchase content items in the content items 304-306 in some threshold amount of time if presented to the user of the computing device 104.

The prediction market component 112 can receive the predictions output by the predictor agents 114-116 and can rank content items in the content items 304-306 based upon such predictions. The prediction market component 112 may then output at least one of the content items 304-306 as a recommendation to the end user of the computing device 104. The prediction market component 112 subsequently monitors user action to ascertain if the end user has undertaken the predefined action with respect to the at least one content item presented to the user on the display screen of the computing device. For example, the prediction market component 112 can identify that the end user has watched a movie recommended to the user and has assigned a rating to the movie. In another example, if the content items 304-306 represent items purchasable by the end user, the prediction market component 112 can ascertain whether or not the user of the computing device 104 has purchased an item represented by the at least one content item displayed on the display screen of the computing device 104 (e.g., within some threshold amount of time). The prediction market component 112 may then compensate (and optionally penalize) one or more predictor agents in the plurality of predictor agents 114-116 based upon the accuracy of the predictions output by the predictor agents 114-116.

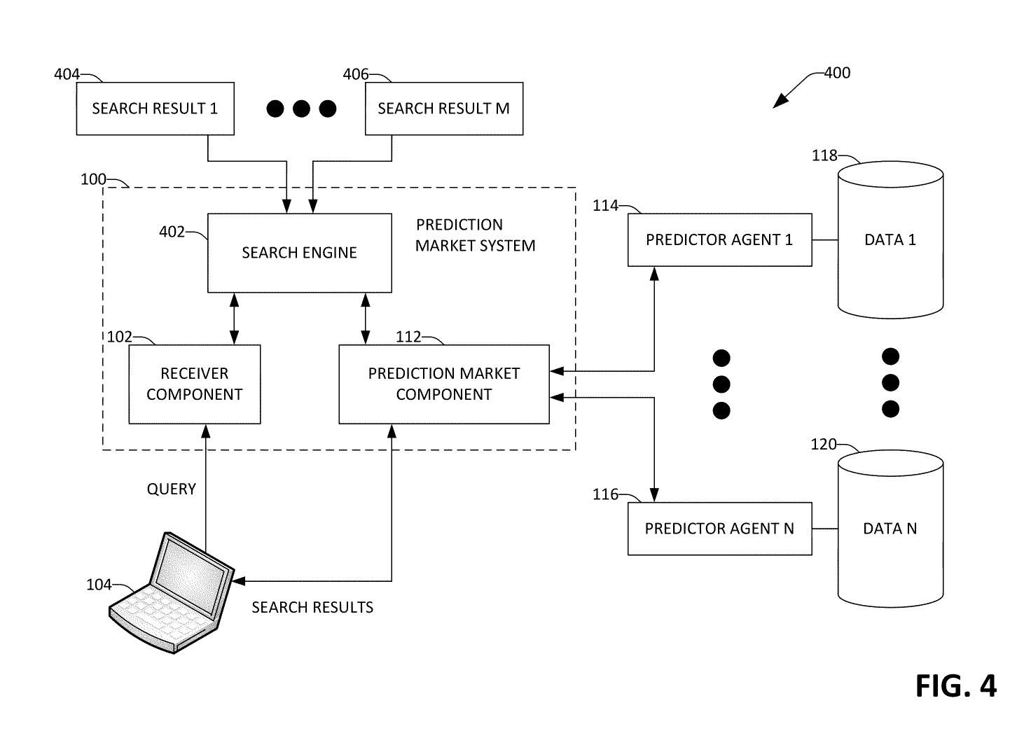

With reference now to FIG. 4, an exemplary system 400 that facilitates utilization of the prediction market system 100 to order organic search results is illustrated. The system 400 includes the prediction market system 100, which comprises the receiver component 102. The receiver component 102 receives a query set forth by the end user of the computing device 104. A search engine 402 can also receive the query and can retrieve a plurality of search results 404-406 based upon the query. Further, optionally, the search engine 402 can be configured to rank the plurality of search results 404-406 through utilization of a suitable ranking algorithm. The prediction market component 112 receives the plurality of search results 404-406 retrieved by the search engine 402.

The prediction market system 100 can provide the query set forth by the end user of the computing device 104 (and optionally other contextual information) and the search results 404-406 retrieved by the search engine 402 to the plurality of predictor agents 114-116. The predictor agents 114-116 can then use their respective private data 118 and 120 to generate predictions with respect to the search results 404-406, wherein the predictions can indicate respective likelihoods of the search results satisfying the information retrieval intent of the end user. For instance, the first predictor agent 114 can predict that the end user of the computing device 104 is likely to find the first search result 404 most relevant to the information retrieval intent of the end user, and can output a prediction indicating as much to the prediction market component 112. The prediction market component 112 may then rank the search results in the plurality of search results 404-406 based upon predictions as to the relevancy of such search results to end the user output by the respective predictor agents 114-116.

The prediction market component 112 may then cause the search results to be provided to the user of the computing device 104, ranked based upon the predictions generated by the plurality of predictor agents 114-116. The prediction market component 112 may then monitor activity of the end user on the computing device 104 to ascertain how the user interacts with the search results presented thereto. For instance, the prediction market component 112 can identify one or more search results that were selected by the user of the computing device 104, can identify a reformulation of the query, a new search session, etc. The prediction market component 112 may then optionally be configured to compensate or penalize third parties corresponding to the predictor agents 114-116 as a function of accuracy of the predictions generated by the predictor agents 114-116.

Utilization of the predictor agents 114-116, in connection with a general-purpose search engine may be particularly well-suited in connection with searching through niche areas/search verticals. For example, while the search engine 402 may perform reasonably well as a general-purpose search engine, the predictor agents 114-116 can be designed to have enhanced performance in certain subject matters (or for certain demographics). The system 400 is therefore mutually beneficial to the search engine 402 and the predictor agents 114-116, as performance of the search engine 402, from the perspective of users, is improved with respect to certain types of queries/demographics, while the predictor agents 114-116 are compensated for generating relatively highly accurate predictions.

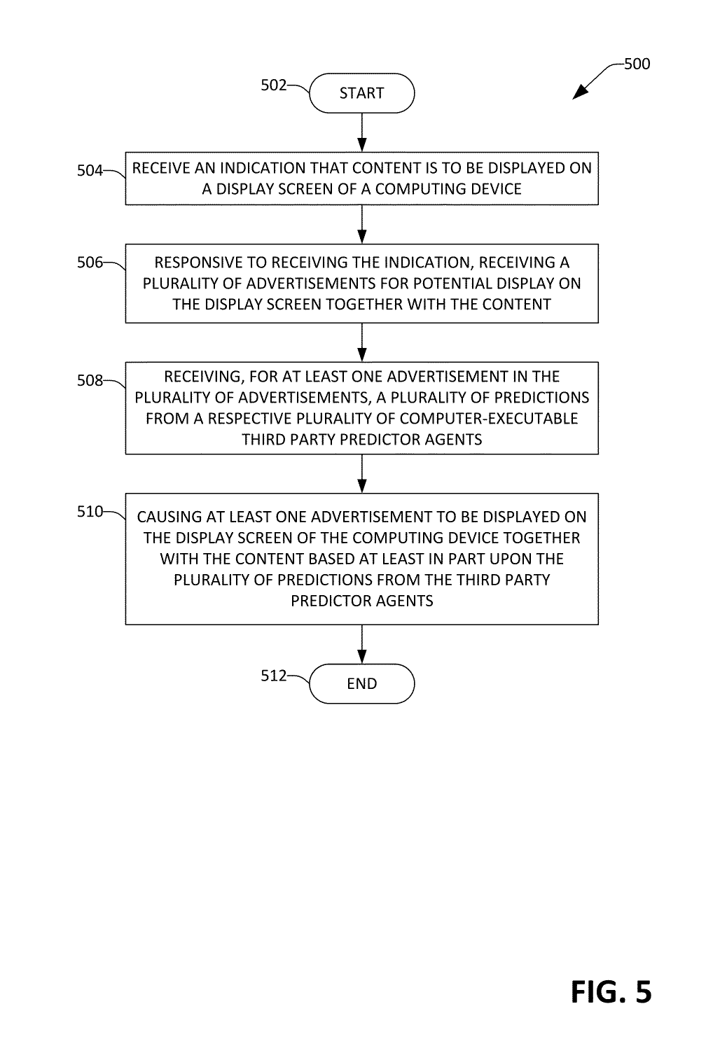

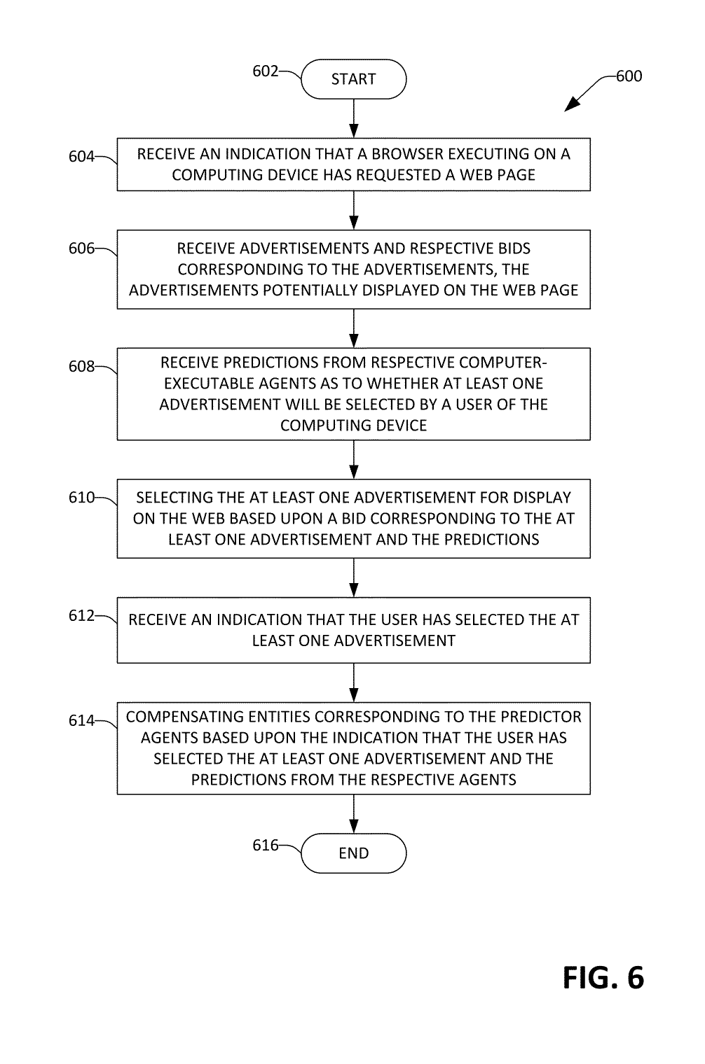

FIGS. 5-6 illustrate exemplary methodologies relating to a real-time prediction market. While the methodologies are shown and described as being a series of acts that are performed in a sequence, it is to be understood and appreciated that the methodologies are not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Now referring to FIG. 5, an exemplary methodology 500 that facilitates causing an advertisement to be displayed on a display screen of a computing device as a function of predictions generated by a plurality of predictor agents is illustrated. The methodology 500 starts at 502, and at 504 an indication is received that publisher content is to be displayed on the display screen of a computing device. For instance, receiving the indication can comprise detecting that a web browser has been directed to a web page, and wherein the publisher content comprises content of the web page. In another example, receiving the indication can comprise receiving a query, wherein the content comprises search results returned by a search engine based upon the query. In still yet another example, receiving the indication can comprise receiving data that identifies content to be presented to the user by an application executing on the computing device, wherein the application is other than a browser (e.g., a maps application, a news application, etc.).

At 506, responsive to receiving the indication at 504, a plurality of advertisements for potential display on the display screen of the computing device together with the publisher content is received. As indicated above, the plurality of advertisements can include advertisements that have bids corresponding thereto for presentment together with the content.

At 508, for at least one advertisement in the plurality of advertisements, a plurality of predictions are received from a respective plurality of computer-executable third party predictor agents. The predictions can be likelihoods of selection of the advertisement by the user of the computing device when the advertisement is displayed together with the content requested by the computing device.

At 510, at least one advertisement is caused to be displayed on the display screen of the computing device together with the publisher content based at least in part upon the plurality of predictions from the third party predictor agents. As indicated above, third parties corresponding to the third party predictor agents can be compensated as a function of user interaction with the advertisement. For example, it can be detected that the user has selected the advertisement when displayed together with the publisher content. Responsive to such detection, a first third party corresponding to a first third party predictor agent can be compensated based upon a first prediction from the first third party predictor agent and the detecting that the user has selected the advertisement. Thus, the first third party predictor agent may have predicted a high likelihood of selection of the advertisement by the user. Additionally, a second third party corresponding to a second third party predictor agent can be compensated based upon a second prediction from the second third party predictor agent, wherein compensation to the first third party is different from compensation to the second third party. For instance, the second third party predictor agent may have indicated a lower likelihood of selection than the first third party predictor agent. If it is detected that the user has selected the advertisement, the first third party can be more highly compensated than the second third party. Moreover, as indicated above, third parties may optionally be monetarily penalized for relatively poor predictions. The methodology 500 completes at 512.

Now referring to FIG. 6, an exemplary methodology 600 that facilitates executing a prediction market is illustrated. The methodology 600 starts at 602, and at 604, an indication is received that a browser executing on a computing device has requested a web page. The web page corresponds to a particular publisher and includes certain content. Such content can include text, images, animation, video, etc.

At 606, responsive to receiving the indication at 604, advertisements and respective bids corresponding to the advertisers are received, wherein the advertisements are potentially displayed in the web page on a display screen of the computing device. At 608, responsive to receiving the advertisements, predictions from respective computer-executable predictor agents are received, wherein the predictions are as to whether at least one advertisement in the plurality of advertisements will be selected by a user of the computing device when displayed in the web page. At 610, responsive to receiving the predictions, the at least one advertisement is selected for display in the web page based upon a bid corresponding to the at least one advertisement and the predictions from the respective computer-executable predictor agents. Thereafter, the browser can load the requested web page such that the web page includes the selected advertisement. It is to be understood that the acts 604-610 can occur in real-time, such that from the perspective of the user, the web page loaded by the browser includes the advertisement selected for display at 610.

At 612, an indication is received that the user has selected the at least one advertisement. For instance, the user can click on the at least one advertisement or perform some other predefined act with respect to the at least one advertisement. At 614, entities corresponding to the respective predictor agents are compensated based upon the indication that the user has selected the at least one advertisement and the predictions from the respective predictor agents. The methodology 600 completes at 616.

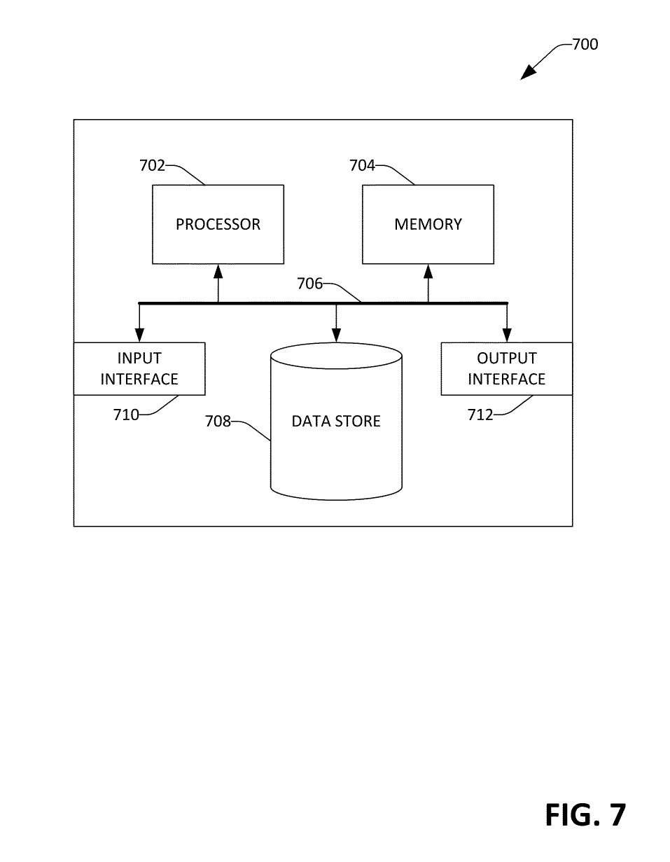

Referring now to FIG. 7, a high-level illustration of an exemplary computing device 700 that can be used in accordance with the systems and methodologies disclosed herein is illustrated. For instance, the computing device 700 may be used in a system that supports a real-time prediction market for advertisements. By way of another example, the computing device 700 can be used in a system that supports a real-time prediction market for organic search results. The computing device 700 includes at least one processor 702 that executes instructions that are stored in a memory 704. The instructions may be, for instance, instructions for implementing functionality described as being carried out by one or more components discussed above or instructions for implementing one or more of the methods described above. The processor 702 may access the memory 704 by way of a system bus 706. In addition to storing executable instructions, the memory 704 may also store advertisements, bids corresponding to advertisements, predictions made by predictor agents, etc.

The computing device 700 additionally includes a data store 708 that is accessible by the processor 702 by way of the system bus 706. The data store 708 may include executable instructions, advertisements, bids, historic predictions, etc. The computing device 700 also includes an input interface 710 that allows external devices to communicate with the computing device 700. For instance, the input interface 710 may be used to receive instructions from an external computer device, from a user, etc. The computing device 700 also includes an output interface 712 that interfaces the computing device 700 with one or more external devices. For example, the computing device 700 may display text, images, etc. by way of the output interface 712.

It is contemplated that the external devices that communicate with the computing device 700 via the input interface 710 and the output interface 712 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 700 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 700 may be a distributed system. Thus, for instance, several devices may be in communication by way of a network connection and may collectively perform tasks described as being performed by the computing device 700.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. A method, comprising:
receiving an indication that content is to be displayed on a display screen of a computing device;
responsive to receiving the indication, receiving a plurality of advertisements for potential display on the display screen together with the content;
receiving, for at least one advertisement in the plurality of advertisements, a plurality of predictions from a respective plurality of computer-executable third party predictor agents, the predictions being indicative of likelihood of selection of the advertisement by a user of the computing device when displayed together with the content as respectively computed by the third party predictor agents; and
causing the at least one advertisement to be displayed on the display screen of the computing device together with the content based at least in part upon the plurality of predictions from the third party predictor agents.

2. The method of claim 1, further comprising:
detecting that the advertisement has been selected when displayed together with the content on the display screen of the computing device; and
compensating a first third party corresponding to a first third party predictor agent from the plurality of third party predictor agents based upon a first prediction from the first third party predictor agent and the detecting that the advertisement has been selected.

3. The method of claim 2, further comprising compensating a second third party corresponding to a second third party predictor agent from the plurality of third party predictor agents based upon a second prediction from the second third party predictor agent and the detecting that the advertisement has been selected, wherein compensation to the first third party is different from compensation to the second third party.

4. The method of claim 1, wherein receiving the indication that the content is to be displayed on the display screen of the computing device comprises detecting that a web browser has been directed to a web page, and wherein the content is content of the web page.

5. The method of claim 1, wherein receiving the indication that the content is to be displayed on the display screen of the computing device comprises receiving a query, wherein the content comprises search results returned by a search engine based upon the query.

6. The method of claim 1, wherein receiving the indication that the content is to be displayed on the display screen of the computing device comprises receiving data that identifies content to be presented by an application executing on the computing device, the application being other than a browser.

7. The method of claim 1, the computing device being a mobile computing device, where the advertisement is configured for display on the mobile telephone.

8. The method of claim 1, further comprising:
assigning respective weights to the third party predictor agents, the weights being respectively indicative of historic accuracies of predictions generated by the third party predictor agents, and wherein causing the at least one advertisement to be displayed on the display screen of the computing device comprising selecting the at least one advertisement from the plurality of advertisements based upon the respective weights assigned to the third party predictor agents.

9. The method of claim 1, further comprising:
detecting that a user has failed to select the advertisement when displayed together with the content on the display screen of the computing device; and
compensating a first third party corresponding to a first third party predictor agent from the plurality of third party predictor agents based upon a first prediction from the first third party predictor agent and the detecting that the user has failed to select the advertisement.

10. The method of claim 1, further comprising:
receiving a wager amount from a first third party predictor agent from the plurality of third party predictor agents, the wager associated with a first prediction set forth by the first third party predictor agent;
detecting that the advertisement has been selected when displayed together with the content on the display screen of the computing device; and
compensating a first third party corresponding to the first third party predictor agent from the plurality of third party predictor agents based upon the first prediction from the first third party predictor agent, the detecting that the advertisement has been selected, and the wager amount from the first third party predictor agent.

11. A system, comprising:
a processor; and
a memory that comprises a plurality of components that are executed by the processor, the plurality of components comprising:
a receiver component that receive an indication that content is to be displayed on a display screen of a computing device;
a prediction market component in communication with the receiver component, the prediction market component receiving a plurality of advertisements that are potentially displayed together with the content on the display screen, the prediction market component executing a real-time prediction market for the plurality of advertisements by receiving predictions from a plurality of computer-executable third party predictor agents as to whether respective advertisements in the plurality of advertisements will be selected when displayed together with the content, the prediction market component selecting an advertisement for display on the display screen together with the content based upon the predictions received from the plurality of third party predictor agents.

12. The system of claim 11, wherein the prediction market component comprises a compensator component that monetarily compensates at least one third party that corresponds to at least one third party predictor agent based upon a prediction set forth by the third party predictor agent being correct.

13. The system of claim 11, wherein the prediction market component comprises a penalty component that assesses a monetary penalty to at least one third party that corresponds to at least one third party predictor agent based upon a prediction set forth by the at least one third party predictor agent being incorrect.

14. The system of claim 11, wherein a first prediction set forth by a first third party predictor agent corresponding to a first advertisement in the plurality of advertisements has a confidence value assigned thereto, the prediction market component comprising:
a detector component that detects that the first advertisement has been selected when displayed together with the content; and
a compensator component that monetarily compensates a third party corresponding to the first third party predictor agent based upon the detector component detecting that the first advertisement has been selected, the first prediction, and the confidence value assigned to the first prediction.

15. The system of claim 14, wherein the real-time prediction market is unsubsidized by the system such that third parties corresponding to third party predictor agents with relatively high prediction accuracy are compensated by the compensator component at an expense of third parties corresponding to third party predictor agents with relatively low prediction accuracy.

16. The system of claim 14, wherein the real-time prediction market is subsidized by the system such that third parties corresponding to third party predictor agents with relatively low prediction accuracy are not monetarily penalized for incorrect predictions while the compensator component monetarily compensates third parties corresponding to third party predictor agents with relatively high prediction accuracy.

17. The system of claim 11 comprised by a server that is in network communication with the computing device.

18. The system of claim 11, wherein the indication received by the receiver component comprises an indication that a browser executing on the computing device has requested a web page, and wherein the web page comprises the content.

19. The system of claim 11, wherein the indication received by the receiver component comprises an indication that a query has been received by a search engine, and wherein a search results page returned by the search engine responsive to receipt of the query comprises the content.

20. A computer-readable storage medium comprising instructions that, when executed by a processor, cause the processor to perform acts comprising:
receiving an indication that a browser executing on a computing device has requested a web page, the web page comprising content;
responsive to receiving the indication, receiving advertisements and respective bids corresponding to the advertisements, the advertisements potentially displayed on a display screen of the computing device in the web page;
responsive to receiving the advertisements, receiving predictions from respective computer-executable predictor agents as to whether at least one advertisement in the plurality of advertisements will be selected when displayed in the web page;
responsive to receiving the predictions, selecting the at least one advertisement for display in the web page based upon a bid corresponding to the at least one advertisement and the predictions from the respective computer-executable predictor agents;
receiving an indication that the at least one advertisement has been selected; and
compensating entities corresponding to the respective predictor agents based upon the indication that the at least one advertisement has been selected and the predictions from the respective predictor agents.
